(19) United States
(12) Patent Application Publication
(10) Pub. No.: US 2026/0128468 A1
(43) Pub. Date: May 7, 2026

(54) COMPOSITE SEPARATOR AND ELECTROCHEMICAL DEVICE INCLUDING THE SAME

(71) Applicant: SK IE TECHNOLOGY CO., LTD., Seoul (KR)

(72) Inventors: Cheol Min YUN, Daejeon (KR); Dong Jae KIM, Daejeon (KR); Eun Ji OH, Daejeon (KR); Hee Joon JUNG, Daejeon (KR)

(21) Appl. No.: 19/354,159

(22) Filed: Oct. 9, 2025

(30) Foreign Application Priority Data
Nov. 7, 2024 (KR) 10-2024-0156748

(51) Int. Cl. H01M 50/451; H01M 50/403; H01M 50/417; H01M 50/429; H01M 50/434; H01M 50/443; H01M 50/446; H01M 50/457; H01M 50/489

(52) U.S. Cl. CPC H01M 50/451; H01M 50/403; H01M 50/417; H01M 50/4295; H01M 50/434; H01M 50/443; H01M 50/446; H01M 50/457; H01M 50/489

(57) ABSTRACT

Composite separators, methods for manufacturing the composite separators, and electrochemical devices including the composite separators are disclosed. In an embodiment, a composite separator includes a porous substrate, and a ceramic layer disposed on at least one surface of the substrate and including inorganic particles and a binder, wherein the binder includes carboxymethyl cellulose having a weight-average molecular weight in a range of 180,000 to 280,000 g/mol and a degree of substitution in a range of 0.6 to 1.2. The composite separator may exhibit excellent mechanical and thermal stability and ion conduction properties.

### PRIORITY CLAIM AND CROSS-REFERENCE TO RELATED APPLICATIONS

This patent document claims the priority and benefits of Korean Patent Application No. 10-2024-0156748, filed on Nov. 7, 2024, the disclosure of which is incorporated herein by reference in its entirety.

### TECHNICAL FIELD

The disclosed technology relates to a separator and an electrochemical device including the same.

### BACKGROUND

In recent years, as electrochemical devices have gained greater capacity and output, there has been a growing demand for improved heat resistance and safety. In particular, the required performance of the separator, which is a very important component of electrochemical devices, has been advancing to meet these needs.

### SUMMARY

An embodiment of the disclosed technology provides a composite separator including: a porous substrate; and a ceramic layer disposed on at least one surface of the porous substrate and including pores formed between inorganic particles that are connected and fixed by a binder. The composite separator exhibits both excellent heat resistance and adhesive strength.

Another embodiment of the disclosed technology provides an electrochemical device that includes the composite separator to provide excellent battery performance and safety.

In one general aspect, a composite separator includes: a porous substrate; and a ceramic layer disposed on at least one surface of the substrate and including inorganic particles and a binder, wherein the binder includes carboxymethyl cellulose having a weight-average molecular weight in a range of 180,000 to 280,000 g/mol and a degree of substitution in a range of 0.6 to 1.2.

In some embodiments, the weight-average molecular weight of the carboxymethyl cellulose may be in a range of 200,000 to 250,000 g/mol.

In some embodiments, the degree of substitution of the carboxymethyl cellulose may be in a range of 0.7 to 1.0.

In some embodiments, the binder may be included in an amount of 0.1 to 10 parts by weight relative to 100 parts by weight of the inorganic particles.

In some embodiments, the binder may include at least 70 wt % of the carboxymethyl cellulose with respect to a total weight of the binder. In some embodiments, the binder may consist of the carboxymethyl cellulose.

In some embodiments, the inorganic particles may include at least one of boehmite, BaSO₄, CeO₂, MgO, CaO, ZnO, Al₂O₃, TiO₂, BaTiO₃, HfO₂, SrTiO₃, SnO₂, NiO, ZrO₂, Y₂O₃, or SiC.

In some embodiments, the inorganic particles may have an average particle diameter in a range of 0.1 μm to 1.0 μm.

In some embodiments, the porous substrate may be hydrophilically surface-treated to be hydrophilic.

In some embodiments, the ceramic layer may have a total thickness in a range of 0.5 μm to 10 μm.

In some embodiments, the composite separator may exhibit heat shrinkage rates in machine direction (MD) and transverse direction (TD) of 4% or less, wherein the heat shrinkage rates in MD and TD are measured after the composite separator is allowed to stand at 150° C. for 60 minutes.

In some embodiments, when the composite separator is subjected to a cardboard test, a ratio of an area occupied by foreign matter smeared on a surface of a cardboard to a total area of the cardboard may be 5% or less.

Here, the cardboard test comprises: placing a black cardboard and a rubber pad having a size of 2 cm×10 cm sequentially on a ceramic layer of a composite separator specimen having a size of 5 cm×10 cm; pulling the cardboard horizontally at a speed of 0.1 m/s while applying a pressure of 10 N to the rubber pad using a pressing device; and evaluating a degree of foreign matter smeared on the surface of the cardboard.

In another general aspect, a method for manufacturing a composite separator includes: applying a composition for forming a ceramic layer including a binder and inorganic particles to at least one surface of a porous substrate; and drying the composition to form a ceramic layer, wherein the binder includes carboxymethyl cellulose having a weight-average molecular weight in a range of 180,000 to 280,000 g/mol and a degree of substitution in a range of 0.6 to 1.2.

In still another general aspect, an electrochemical device includes a positive electrode, a negative electrode, and a composite separator between the positive and negative electrodes, wherein the composite separator includes a porous substrate and a ceramic layer disposed on at least one surface of the substrate and includes inorganic particles and a binder, wherein the binder includes carboxymethyl cellulose having a weight-average molecular weight of in a range 180,000 to 280,000 g/mol and a degree of substitution in a range of 0.6 to 1.2.

Other features and aspects will be apparent from the following detailed description, the drawings, and the claims.

### BRIEF DESCRIPTION OF THE DRAWINGS

FIG. 1 shows a cross section of an example of a composite separator based on an example embodiment.

### DETAILED DESCRIPTION

The numerical range used in some embodiments includes all values within the range including the lower limit and the upper limit, increments logically derived from the form and spanning of a defined range, all double limited values, and various other suitable combinations of the upper limit and the lower limit in the numerical range defined in different forms. Unless otherwise defined in this patent document, values which may be outside a numerical range due to experimental error or rounding off of a value are also included in the defined numerical range.

Unless otherwise particularly defined in embodiments, “about” may be considered as a value within 30%, 25%, 20%, 15%, 10%, or 5% of a stated value.

In some embodiments, “average particle diameter” refers to “D50”, and “D50” refers to a particle diameter of an inorganic particle corresponding to 50% in terms of a volume-based integrated fraction: 50% of the particles have diameters that are less than the diameter D50. The average particle diameter may be derived from particle size distribution results obtained by collecting a sample of inorganic particles to be measured in accordance with the standard of ISO 13320-1 and performing analysis using analytical instruments for particle size and shape (e.g., S3500 available from MICROTRAC). In addition, “D90” refers to a particle diameter of a particle corresponding to 90% in the volume-based integrated fraction (90% of the particles have diameters that are less than the diameter D90), and “D10” refers to a particle diameter of an inorganic particle corresponding to 10% in a volume-based integrated fraction (10% of the particles have diameters that are less than the diameter D10). D90 and D10 may be derived in the same manner as D50.

In some embodiments, carboxymethyl cellulose (CMC) refers to a cellulose derivative that is etherified by substituting a hydroxyl group (—OH) of cellulose with —OCH₂COOH and/or —OCH₂COO—M⁺ where M⁺ is an alkali metal cation selected from lithium (Li), sodium (Na), potassium (K), rubidium (Rb), cesium (Cs), and francium (Fr). In some embodiments, the term “degree of substitution (DS)” of carboxymethyl cellulose refers to the number of substituents present in one anhydrous glucose unit in a cellulose molecule. The DS value may be measured by a known or conventional method, for example, in accordance with ASTM D1439, or calculated by ¹H-NMR or ¹³C-NMR analysis.

To enhance the heat resistance and safety of a separator of a battery, a composite separator has been developed in which a coating layer, including inorganic particles such as alumina (Al₂O₃), silica (SiO₂), and zirconia (ZrO₂) together with a binder, is applied to a porous substrate. However, research is now focusing on thinning separators to achieve higher capacity and output in electrochemical devices. Certain binders applied to composite separators often lack sufficient adhesive strength to both the substrate and the inorganic particles. As a result, when the inorganic particle coating layer becomes thinner, the mechanical strength and/or heat resistance of the separator may decrease.

Research to address the above-discussed issues is ongoing. However, in some cases, binder materials with improved heat resistance often have insufficient adhesive strength. In other cases, when adhesive strength of separators is improved, other properties such as air permeability and interfacial resistance tend to deteriorate, leading to reduced device performance.

Hereinafter, the disclosed technology will be described in detail. However, it is only illustrative, and the disclosed technology is not limited to the specific embodiment illustratively described.

Some embodiments of the disclosed technology provide a composite separator designed to simultaneously ensure excellent mechanical stability, thermal stability, and ion conduction properties.

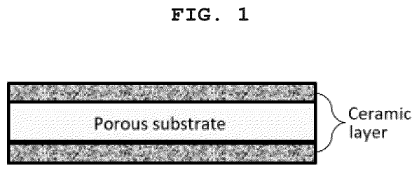

Specifically, the composite separator implemented based on an example embodiment includes: a porous substrate; and a ceramic layer disposed on at least one surface (e.g., one surface or two opposing surfaces) of the substrate. See FIG. 1 for an example of a suitable structure of such a composite separator. The ceramic layer on a surface of the porous substrate can include inorganic particles and a binder, wherein the binder includes carboxymethyl cellulose having a weight-average molecular weight in a range of 180,000 to 280,000 g/mol and a degree of substitution in a range of 0.6 to 1.2.

In an example embodiment, the composite separator uses, as the binder, the carboxymethyl cellulose meeting both the weight-average molecular weight and the degree of substitution as described above. This composite separator may exhibit excellent adhesive strength between the inorganic particles and between the inorganic particles and the substrate, as well as excellent heat resistance. In addition, these properties are maintained even when the ceramic layer is formed with a very small thickness. As a result, an electrochemical device including this composite separator may simultaneously achieve safety, a high capacity, and high output characteristics.

In an example embodiment, the carboxymethyl cellulose may have a weight-average molecular weight of 180,000 to 280,000 g/mol, 180,000 to 260,000 g/mol, 180,000 to 250,000 g/mol, 190,000 to 250,000 g/mol, or 200,000 to 250,000 g/mol, and may include various other suitable combinations of the upper limits and the lower limits of these numerical ranges. In some embodiments, the weight-average molecular weight may refer to a weight-average molecular weight converted with a molecular weight calibration curve using a polysaccharide standard sample measured by a gel permeation chromatography (GPC) method.

In addition, the carboxymethyl cellulose may have the degree of substitution of 0.6 to 1.2, 0.6 to 1.1, 0.6 to 1.0, 0.7 to 1.2, 0.7 to 1.1, 0.7 to 1.0, 0.8 to 1.2, 0.8 to 1.1, 0.8 to 1.0, 0.9 to 1.2, 0.9 to 1.1, or 0.9 to 1.0, and may include various other suitable combinations of the upper limits and the lower limits of these numerical ranges. By using the carboxymethyl cellulose meeting both the weight-average molecular weight and the degree of substitution range, both the heat resistance and adhesive strength may be further improved. For example, the carboxymethyl cellulose may improve applicability for coating slurry application on the surface of the porous substrate when forming the ceramic layer, provide excellent heat resistance when the ceramic layer on the composite separator is very thin, and improve adhesive strength between the inorganic particles or between the ceramic layer and the porous substrate.

In an example embodiment, any type of inorganic particles may be used without limitation as long as it is commonly used in the art. As a non-limiting example, the inorganic particles may include one or more selected from metal oxides, metal hydroxide, metal carbides, metal nitrides, and metal carbonitrides, such as boehmite, BaSO₄, CeO₂, MgO, CaO, ZnO, Al₂O₃, TiO₂, BaTiO₃, HfO₂, SrTiO₃, SnO₂, NiO, ZrO₂, Y₂O₃, and SiC. In some embodiments, the inorganic particles may include materials other than those listed above.

In an example embodiment, the inorganic particles may have an average particle diameter (D50) of, for example, 0.1 μm to 10.0 μm, 0.1 μm to 5.0 μm, 0.1 μm to 3.0 μm, 0.1 μm to 2.0 μm, 0.1 μm to 1.0 μm, or 0.1 μm to 0.5 μm, or may include various other suitable combinations of the upper limits and the lower limits of the numerical ranges. However, the disclosed technology is not limited thereto.

In an example embodiment, the ceramic layer may include 90 to 99.9 wt %, 92 to 99.5 wt %, or 92 to 99 wt % of the inorganic particles with respect to the total weight of the ceramic layer. When compared with the content of the inorganic particles in a conventional coating layer formed by connecting inorganic particles including the binder, the ceramic layer implemented based on some embodiments may include more inorganic particles. Since heat resistance and numerical stability are excellent, the coating layer (ceramic layer) may be formed at a smaller thickness.

In an example embodiment, the ceramic layer may use the binder at 10 parts by weight or less, 8 parts by weight or less, 5 parts by weight or less, 3 parts by weight or less, 2 parts by weight or less, or 1 part by weight or less and 0.1 parts by weight or more, 0.5 parts by weight or more, 1 part by weight or more, 2 parts by weight or more, specifically 0.1 to 5 parts by weight, 1 to 5 parts by weight, or 1 to 3 parts by weight, with respect to 100 parts by weight of the inorganic particles, or at a content between the numerical ranges. The binder may use the carboxymethyl cellulose at 70 wt % or more, 80 wt % or more, 90 wt % or more, 95 wt % or more, or 100 wt %, with respect to the total weight of the binder. In some embodiments, the carboxymethyl cellulose may be used alone (100 wt %).

Since the composite separator based on an example embodiment uses carboxymethyl cellulose meeting both the weight-average molecular weight and the degree of substitution as described above, the composite separator can exhibit excellent adhesive strength between the inorganic particles and between the inorganic particles and the substrate and heat resistance even when the carboxymethyl cellulose is used alone as the binder of the ceramic layer.

In addition, in an example embodiment, when carboxymethyl cellulose having the weight-average molecular weight of 180,000 to 280,000 g/mol and the degree of substitution of carboxymethyl of 0.6 to 1.2 is adopted, a binder may be further included. Examples of the binder may include one or more selected from polyvinylidene fluoride (PVdF), hexafluoro propylene (HFP), polyvinylidene fluoride-co-hexafluoro propylene, polyvinylidene fluoridecotrichloroethylene, polymethyl methacrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetate propionate, cyanoethylpullulan, cyanoethyl polyvinyl alcohol, cyanoethyl cellulose, pullulan, cyanoethyl sucrose, carboxymethyl cellulose, styrene-butadiene rubber, acrylonitrile-styrene-butadiene copolymer, and polyimide. In some embodiments, the binder may include materials other than those listed above. In some embodiments, the binder may include any polymer that can be used in a separator or an electrode active material without limitation.

In an example embodiment, heat shrinkage rates in MD and TD directions of the composite separator, measured after the separator is allowed to stand at 150° C. for 60 minutes, may each be 5% or less, specifically 4% or less, 3% or less, or 2.5% or less.

In addition, in an example embodiment, when a degree of foreign matter smeared on the surface of a cardboard is evaluated after a cardboard test of the composite separator, a ratio of an area occupied by the smeared foreign matter to an area of the cardboard may be 5% or less, specifically less than 5%, less than 4%, less than 3%, less than 2%, or less than 1.5%.

The cardboard test method involves placing a black cardboard and a rubber pad having a size of 2 cm×10 cm sequentially on an upper surface of a ceramic layer of a composite separator specimen having a size of 5 cm×10 cm, and pulling out the cardboard horizontally at a speed of 0.1 m/s in a state of applying a pressure of 10 N to the rubber pad using a pressing device to evaluate an area as a degree of foreign matter smeared on the surface of the cardboard, in which the foreign matter may be the constituent components of the ceramic layer, for example, the inorganic particles, the binder, or a combination thereof.

When the adhesive strength is evaluated using the cardboard test method as described above, measurement may be performed considering adhesive strength between the inorganic particles in the ceramic layer as well as adhesive strength between interfaces of the substrate and the ceramic layer, and from the results of the adhesive strength test, a heat shrinkage degree may be predicted more accurately as compared with a conventional peel test. That is, when a ratio of an area occupied by the smeared foreign matter calculated by the cardboard test is less than 5%, less than 4%, less than 3%, less than 2%, or less than 1.5%, it means that adhesive strengths between the inorganic particles and between the inorganic particles and the substrate are all excellent, and the heat shrinkage phenomenon may be effectively suppressed.

As an example, a method such as a peeling test commonly used for evaluating adhesive strength of an inorganic particle coating layer in a composite separator can be used to evaluate adhesive strength between interfaces of the substrate and the inorganic particle coating layer. However, it may be difficult to evaluate the adhesive strength between the inorganic particles, or the evaluated value may not accurately reflect the heat shrinkage characteristics of the separator.

In an example embodiment, the porous substrate is not limited as long as it is commonly used in the art, and for example, may be a woven fabric, a non-woven fabric, or a porous film. Specifically, the porous substrate may be polyolefins such as polyethylene and polypropylene, polyesters such as polyethylene terephthalate and polybutylene terephthalate, polyacetal, polyamide, polyimide, polycarbonate, polyetheretherketone, polyaryletherketone, polyetherimide, polyamideimide, polybenzimidazole, polyethersulfone, polyphenyleneoxide, cyclic olefin copolymer, polyphenylenesulfide, polyethylenenaphthalate, glass fiber, teflon, and/or polytetrafluoroethylene, and any two or more of them may be used. Among the porous substrates, a porous film is manufactured by a dry method or a wet method known in the art.

In an example embodiment, the porous substrate may have a porosity of 20 to 60%, 30 to 60%, 30 to 50%, or 35 to 45%, but the disclosed technology is not limited thereto.

In an example embodiment, the porous substrate may include a polar functional group material introduced by performing a hydrophilic surface treatment to render the treated porous substrate to be hydrophilic or increase the affinity to water. In implementations, the polar functional group may be a carboxyl group, an aldehyde group, a hydroxyl group, or others, and the hydrophilic surface treatment may be, as an a corona discharge treatment or a plasma discharge treatment, but the disclosed technology is not limited thereto.

In an example embodiment, the thickness of the porous substrate is not particularly limited, and for example, may be 1 μm to 100 μm, 1 μm to 50 μm, 1 μm to 30 μm, 5 μm to 20 μm, or any value between the numerical values.

In an example embodiment, the ceramic layer may be coated on one or two different surfaces of the porous substrate, and when the ceramic layer is coated on both surfaces of the porous substrate, the thicknesses of the ceramic layer coated on one surface and the other surface may be the same as or different from each other. Although not particularly limited, the total thickness of the ceramic layer implemented based on an example embodiment may be, for example, 0.1 μm to 10.0 μm, 0.5 μm to 10.0 μm, 1 μm to 10 μm, 1 μm to 8 μm, 1 μm to 5 μm, about 1.5 μm to 5 μm, 2 μm to 5 μm, 2 μm to 4 μm, or a value between the numerical values. Since the composite separator based on an example embodiment may maintain excellent adhesive strength and heat resistance even when the ceramic layer is very thin, an electrochemical device employing the separator may satisfy safety, a high capacity, and high output characteristics simultaneously.

Another example embodiment of the disclosed technology provides a method for manufacturing a composite separator including: applying a composition for forming a ceramic layer including a binder and inorganic particles to at least one surface of a porous substrate and drying the composition to form a ceramic layer, wherein the binder includes carboxymethyl cellulose having a weight-average molecular weight in a range of 180,000 to 280,000 g/mol and a degree of substitution in a range of 0.6 to 1.2.

Since the porous substrate, the binder, and the inorganic particles are as described above, a detailed description thereof will be omitted.

The composition for forming a ceramic layer may be prepared by dispersing the binder and the inorganic particles, and the agglomerated inorganic particles may be dispersed using a ball mill.

The composition for forming a ceramic layer further includes a solvent, and the solvent may be water, lower alcohols such as ethanol, methanol, and propanol, solvents such as dimethylformamide, acetone, tetrahydrofuran, diethyl ether, methylene chloride, N-ethyl-2-pyrrolidone, hexane, and cyclohexane, or a mixture thereof, but is not necessarily limited thereto.

In an example embodiment, although a solid content of the composition for forming a ceramic layer is not particularly limited, it may be, for example, 1 to 50 wt %, 5 to 30 wt %, or 10 to 30 wt %, but the disclosed technology is not limited thereto. In addition, the composition for forming a ceramic layer may have a viscosity based on a solid content of 25 wt % of 800 to 5,000 mPa·s, 800 to 4,000 mPa·s, 800 to 3,000 mPa·s, or 1,000 to 3,000 mPa·s. At such viscosity, the ceramic layer can be formed more easily, and the heat resistance and adhesive strength of the separator may be further improved.

In an example embodiment, although a method for applying or coating the composition for forming a ceramic layer on the porous substrate is not particularly limited, coating methods such as roll coating, pin coating, dip coating, bar coating, die coating, slit coating, or inkjet printing may be used.

In an example embodiment, the drying may be performed by drying by warm air, hot air, or low-humidity air, vacuum drying, or irradiation with far infrared rays, electron beams, or others. Since the drying temperature is not particularly limited, it may be appropriately adjusted depending on the experimental environment or the purpose, and for example, may be 30° C. to 120° C., 30° C. to 100° C., 50° C. to 80° C., or 50° C. to 70° C. The drying time is not particularly limited, but it may be 30 seconds to 300 seconds, 60 seconds to 300 seconds, 100 seconds to 300 seconds, 150 seconds to 250 seconds, or about 180 seconds.

Another example embodiment of the disclosed technology provides an electrochemical device including the composite separator according to an example embodiment, and the electrochemical device may be, as an example, a lithium secondary battery.

Specifically, the electrochemical device based on an example embodiment includes a positive electrode, a negative electrode spaced from the positive electrode, and a composite separator between the positive and negative electrodes. The composite separator includes a porous substrate and a ceramic layer disposed on at least one surface of the substrate and including inorganic particles and a binder, wherein the binder includes carboxymethyl cellulose having a weight-average molecular weight in a range of 180,000 to 280,000 g/mol and a degree of substitution in a range of 0.6 to 1.2.

Hereinafter, the electrochemical device based on an example embodiment will be described using a lithium secondary battery as an example. In some embodiments, the electrochemical device may be manufactured with a structure known in the art using a common manufacturing method and common materials in the art, of course, except for including the composite separator implemented based on an example embodiment of the disclosed technology.

As an example, the lithium secondary battery may be manufactured using a common manufacturing method of placing a negative electrode, the composite separator, and a positive electrode sequentially, assembling them, and injecting an electrolyte to complete the battery.

### [Positive Electrode]

The positive electrode may include a positive electrode current collector and a positive electrode mixed layer on at least one surface of the positive electrode current collector, the positive electrode may be manufactured by forming the positive electrode mixed layer by applying a positive electrode material slurry on one or both surfaces of the positive electrode current collector, drying, and rolling, and the positive electrode material slurry may include a positive electrode active material and a binder, and if necessary, may further include a conductive material, a thickening agent, or others.

The positive electrode current collector may include a stainless steel, nickel, aluminum, titanium, or an alloy thereof, and may include aluminum or a stainless steel which is surface-treated with carbon, nickel, titanium, or silver. The thickness of the positive electrode current collector may be, for example, 10 μm to 50 μm, but the disclosed technology is not limited thereto.

The positive electrode active material is a compound capable of reversibly intercalating and deintercalating lithium ions and may be used without limitation as long as it is commonly used in the art, and as a non-limiting example, it may be a composite oxide of lithium with a metal selected from cobalt (Co), manganese (Mn), nickel (Ni), iron (Fe), niobium (Nb), magnesium (Mg), copper (Cu), zinc (Zn), molybdenum (Mo), tantalum (Ta), tungsten (W), aluminum (Al), or a combination thereof.

In an example embodiment, the positive electrode active material may be a lithium-nickel composite oxide, and the lithium-nickel composite oxide may further include one or more selected from cobalt, manganese, and aluminum. In some embodiments, the lithium-nickel composite oxide may include materials other than those listed above.

In an example embodiment, the positive electrode active material may include a lithium nickel-cobalt-manganese (NCM)-based composite oxide, and although the composition of the metal is not particularly limited, a high capacity (high-Ni) composition having a high nickel content may be used, and the content of Ni in the NCM-based lithium oxide (e.g., a mole fraction of nickel of the total moles of nickel, cobalt, and manganese) may be 0.3 or more, 0.4 or more, 0.5 or more, 0.6 or more, 0.7 or more, or 0.8 or more. In some example embodiments, the content of Ni may be 0.8 to 0.95, 0.82 to 0.95, 0.83 to 0.95, 0.84 to 0.95, 0.85 to 0.95, or 0.88 to 0.95. The NCM-based composite oxide may be, for example, LiNi_{0.33}CO_{0.33}Mn_{0.33}O₂, LiNi_{0.4}CO_{0.2}Mn_{0.4}O₂, LiNi_{0.5}CO_{0.2}Mn_{0.3}O₂, LiNi_{0.6}Co_{0.2}Mn_{0.2}O₂, LiNi_{0.7}CO_{0.15}Mn_{0.15}O₂, LiNi_{0.8}Co_{0.1}Mn_{0.1}O₂, or others, but the disclosed technology is not limited thereto.

In an example embodiment, the positive electrode active material may be, for example, lithium cobalt oxide-based, lithium manganese oxide-based, lithium nickel oxide-based, lithium iron phosphate-based (LFP, e.g., LiFePO₄), lithium manganese phosphate-based (e.g., LiMnPO₄), lithium cobalt phosphate-based (e.g., LiCoPO₄), lithium iron pyrophosphate-based (e.g., Li₂FeP₂O₇) materials, or others.

The positive electrode binder is not particularly limited as long as it is commonly used in the art. In some embodiments, the positive electrode binder may include a nonaqueous binder and/or an aqueous binder or include a rubber-based binder and/or a fluorine-based binder, and for example, may include one or more selected from acryl-based polymers such as polyacrylate, polymethacrylate, polybutylacrylate, and polyacrylonitrile, fluorine-based polymers such as polyvinylidene fluoride, hexafluoropropylene, polyvinylidene fluoride-hexafluoropropylene, and polyvinylidene fluoride-trichloroethylene, polyvinyl acetate, polyethylene oxide, cellulose, modified cellulose, polyamide, polyacrylamide, rubber, elastomer, or others, but the disclosed technology is not limited thereto. In some embodiments, the positive electrode binder may include materials other than those listed above.

The conductive material may be added for increasing conductivity of the positive electrode mixed layer and/or mobility of lithium ions or electrons. For example, the conductive material may be a linear conductive material and/or a dot-shaped conductive material, and for example, may include carbon-based conductive materials such as graphite, carbon black, acetylene black, ketjen black, graphene, carbon nanotubes, vapor-grown carbon fiber (VGCF), carbon fiber, and carbon nanofiber, and/or metal-based conductive materials including tin, tin oxide, titanium oxide, perovskite materials such as LaSrCoO₃ and LaSrMnO₃, or others, but the disclosed technology is not limited thereto.

### [Negative Electrode]

The negative electrode may include a negative electrode current collector and a negative electrode mixed layer on at least one surface of the negative electrode current collector, the positive electrode may be manufactured by forming the negative electrode mixed layer by applying a negative electrode material slurry on one or both surfaces of the positive electrode current collector, drying, rolling, and the negative electrode material slurry may include a negative electrode active material and a binder, and if necessary, may further include a conductive material, a thickening agent, or others.

The negative electrode current collector may include a copper foil, a nickel foil, a stainless steel foil, a titanium foil, a nickel foam, a copper foam, a polymer substrate coated with a conductive metal, or others. The negative electrode current collector may have a thickness of, for example, 10 μm to 50 μm, but the disclosed technology is not limited thereto.

The negative electrode active material is a material capable of adsorbing and desorbing lithium ions and may be used without limitation as long as it is commonly used in the art, and as a non-limiting example thereof, carbon-based materials such as crystalline carbon, amorphous carbon, a carbon composite, and carbon fiber; lithium metal; lithium alloy; silicon (Si)-containing materials, tin (Sn)-containing materials, or others may be used.

An example of the amorphous carbon may include hard carbon, soft carbon, coke, mesocarbon microbeads (MCMB), mesophase pitch-based carbon fibers (MPCF), or others, and an example of the crystalline carbon may include graphite-based carbon such as natural graphite, artificial graphite, graphitized coke, graphitized MCMB, and graphitized MPCF.

An element included in the lithium alloy may include aluminum, zinc, bismuth, cadmium, antimony, silicon, lead, tin, gallium, indium, or others.

The silicon-containing material may provide more increased capacity characteristics. The silicon-containing material may include Si, SiOₓ (0<x≤2), metal-doped SiOₓ (0<x≤2), a silicon-carbon composite, or others, the metal may include lithium and/or magnesium, and the metal-doped SiOₓ (0x≤2) may include a metal silicate. The materials described above which may be used in manufacture of the positive electrode may be used as the binder, the conductive material, and the thickening agent of the negative electrode.

The negative electrode binder is not particularly limited as long as it is commonly used in the art, and may be rubber-based binders such as a styrene-butadiene rubber (SBR)-based binder, carboxymethyl cellulose (CMC), polyacrylic acid, poly(3,4 ethylenedioxythiophene) (PEDOT)-based binders, or others.

### [Electrolyte]

In an example embodiment, the electrolyte may be a nonaqueous electrolytic solution, and the nonaqueous electrolytic solution may include a lithium salt as an electrolyte and an organic solvent.

The lithium salt is represented by, for example, Li⁺X⁻, and an anion of the lithium salt (X⁻) may be exemplified by F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, or others.

The organic solvent sufficiently dissolves the lithium salt and the additive, and may include an organic compound having no reactivity in a battery. The organic solvent may include, for example, at least one of carbonate-based solvents, ester-based solvents, ether-based solvents, ketone-based solvents, alcohol-based solvents, and aprotic solvents. The organic solvent may include, for example, one or more selected from propylene carbonate, ethylene carbonate, butylene carbonate, diethyl carbonate, dimethyl carbonate, ethyl methyl carbonate, methylpropyl carbonate, ethylpropyl carbonate, dipropyl carbonate, vinylene carbonate, methyl acetate, ethyl acetate, n-propyl acetate, 1,1-dimethylethyl acetate, methyl propionate, ethyl propionate, fluoroethyl acetate, difluoroethyl acetate, trifluoroethyl acetate, dibutylether, tetraethylene glycol dimethylether, diethylene glycol dimethylether, dimethoxyethane, tetrahydrofuran, 2-methyltetrahydrofuran, ethyl alcohol, isopropyl alcohol, dimethylsulfuroxide, acetonitrile, diethoxyethane, sulfolane, γ-butyrolactone, propylene sulfite, or others. In some embodiments, the organic solvent may include materials other than those listed above.

Hereinafter, the example embodiments described above will be described in detail through the following examples. However, the following examples are only for description, and do not limit the scope of a right.

The physical properties of the examples were measured as follows:

### 1) Viscosity

A kinematic viscosity value of a composition for forming a ceramic layer (solid content: 25 wt %) was measured with a rotational rheometer (Discovery HR-20 available from TA) and a flat plate (HA aluminum available from TA, 60 mm plate) spindle having a diameter of 60 mm at a shear speed of 1 (1/s) under a temperature condition of 25° C. and was set as a viscosity value. A sample was loaded on the plate, the spindle was set to a gap of 250 μm, and the shear speed was increased from 1 (1/s) to 10000 (1/s) to measure the kinematic viscosity.

### 2) Thickness

A composite separator was laminated in 10 layers, the thickness was measured by Mitutoyo (ID-C112X) to derive an average thickness of the 10 layers of the composite separator, and the average thickness was divided by 10 again to determine the thickness of the composite separator. A value obtained by subtracting the thickness of a porous substrate (9 μm) from the thickness of the composite separator was set as a total thickness of the ceramic layer.

### 3) Adhesive Strength

### [Cardboard Test]

A composite separator was cut into a size of 5 cm×10 cm to prepare a specimen, and a black cardboard and a rubber pad having a size of 2 cm×10 cm were placed sequentially on the ceramic layer of the composite separator specimen. The cardboard was pulled out horizontally at a speed of 0.1 m/s in a state of applying a pressure of 10 N to the rubber pad using a pressing device, adhesive strength was evaluated depending on a degree of foreign matter smeared on the surface of the cardboard, and the foreign matter may be constituent components of the ceramic layer, for example, inorganic particles, a binder, or a combination thereof.

### [Evaluation of Degree of Smeared Foreign Matter]

After the cardboard test, the surface of the cardboard was photographed with an optical camera and imaged, and an area of the smeared foreign matter was measured. Specifically, an indirect lighting was installed with an LED lamp in the visible light range having a 60° slope, and the cardboard was photographed with a 640 M pixel optical camera at a height of 40 cm from the sample (cardboard). The photographed cardboard image was loaded with an Image J program, only an area through which the separator and the rubber pad were passed was selected and cut using a crop function, an image file format of the cut area was converted into a 8 bit image, and a Sharpen filter was applied to the image to adjust the brightness and the contrast of the image so that it is easy to distinguish between the cardboard and white foreign matter. A threshold was applied to the image to convert it into a binary image, an Analyze Particles function was executed to calculate a ratio of an area occupied by white foreign matter to the total area, and adhesive strength was evaluated based on the following criteria:

$$< 1.5 \% \qquad A$$

$$1.5 \% - 5 \% \qquad B$$

$$> 5 \% \qquad C$$

### 4) Heat Shrinkage Rate

The heat shrinkage rate of the composite separator was measured based on the ASTM D1204 standard, but the following method was used. Lattice points were marked at 2 cm intervals on a square with one side of 10 cm on the composite separator specimen, and one side of the square was the transverse direction (TD) and the other one was the machine direction (MD). The specimen was placed right in the center, 5 sheets of paper were placed on and under the specimen, respectively, the four sides of the paper were taped, and the taped specimen was allowed to stand in a hot air drying oven at 150° C. for 60 minutes. Thereafter, the specimen was taken out, and the separator was observed with a camera to calculate the shrinkage rate in the machine direction (MD) and the shrinkage rate in the transverse direction (MD), which are shown in the following Table 1.

$$MD heat shrinkage rate ( \% ) = ( length in MD before heating - length in MD after heating ) / length in MD before heating \times 100$$

$$TD heat shrinkage rate ( \% ) = ( length in TD before heating - length in TD after heating ) / length in TD before heating \times 100$$

### EXAMPLE 1

2 parts by weight of 1,2-benzisothiazolin-3-one (DIO2) as a dispersing agent was mixed with 100 parts by weight of boehmite having an average particle diameter (D50) of 0.3 μm in water to prepare a slurry having a solid content of 45 wt %. The thus prepared slurry and carboxymethyl cellulose (CMC) having a degree of substitution of 0.95 and a weight-average molecular weight of 250,000 g/mol were mixed so that CMC was 3 parts by weight with respect to 100 parts by weight of the boehmite, and the mixture was diluted with water so that the solid content was 25 wt % to prepare a composition for forming a ceramic layer.

Both surfaces of a polyethylene film having a thickness of 9 μm (porosity: 35%-45%, SKIET) were subjected to a corona discharge treatment (power density: 2 W/mm) to introduce a surface polar group, and the corona surface treatment at this time was performed at a speed of 3 to 20 mpm (meter per minute). The composition for forming a ceramic layer was applied on both surfaces of the corona surface-treated polyethylene film, bar-coated, and dried at 50° C. to manufacture a composite separator having ceramic layers at the same thickness formed on both surfaces.

### EXAMPLES 2 AND 3

The process was performed in the same manner as in Example 1, except that the thickness of the ceramic layer was changed as shown in the following Table 1.

### EXAMPLE 4

The process was performed in the same manner as in Example 1, except that CMC having a degree of substitution of 1.0 and a weight-average molecular weight of 200,000 g/mol was used.

### EXAMPLE 5

The process was performed in the same manner as in Example 1, except that CMC having a degree of substitution of 0.7 and a weight-average molecular weight of 240,000 g/mol was used.

### EXAMPLE 6

The process was performed in the same manner as in Example 1, except that CMC having a degree of substitution of 0.7 and a weight-average molecular weight of 210,000 g/mol was used.

### COMPARATIVE EXAMPLE 1

The process was performed in the same manner as in Example 1, except that CMC having a degree of substitution of 0.9 and a weight-average molecular weight of 60,000 g/mol was used.

### COMPARATIVE EXAMPLE 2

The process was performed in the same manner as in Example 1, except that CMC having a degree of substitution of 0.9 and a weight-average molecular weight of 150,000 g/mol was used.

### COMPARATIVE EXAMPLE 3

The process was performed in the same manner as in Example 1, except that CMC having a degree of substitution of 0.9 and a weight-average molecular weight of 300,000 g/mol was used.

### COMPARATIVE EXAMPLE 4

The process was performed in the same manner as in Example 1, except that CMC having a degree of substitution of 0.5 and a weight-average molecular weight of 230,000 g/mol was used.

### COMPARATIVE EXAMPLE 5

The process was performed in the same manner as in Example 1, except that CMC having a degree of substitution of 1.3 and a weight-average molecular weight of 190,000 g/mol was used.

### COMPARATIVE EXAMPLE 6

The process was performed in the same manner as in Example 1, except that cellulose nanofiber (CNF) was used instead of carboxymethyl cellulose.

TABLE 1

| | CMC | | | Total | | | |
|---|---|---|---|---|---|---|---|
| | Molecular | | | thickness | | Heat shrinkage | |
| | weight | Degree of | Viscosity | of ceramic | Adhesive | rate (%) | |
| | (g/mol) | substitution | (mPa · s) | layer (μm) | strength | MD | TD |
| Example 1 | 250,000 | 0.9 | 1,500 | 2.1 | A | 2 | 1 |
| Example 2 | 250,000 | 0.9 | 1,500 | 3.6 | A | 1.6 | 0.8 |
| Example 3 | 250,000 | 0.9 | 1,500 | 1.6 | A | 2.5 | 2.6 |
| Example 4 | 200,000 | 1.0 | 1,200 | 2.2 | B | 2 | 1 |
| Example 5 | 240,000 | 0.7 | 1,400 | 2.1 | B | 2 | 1 |
| Example 6 | 210,000 | 0.7 | 1,300 | 2.2 | A | 2.1 | 1.2 |
| Comparative | 60,000 | 0.9 | 150 | 2.1 | C | Immeasurable | |
| Example 1 | | | | | | | |
| Comparative | 150,000 | 0.9 | 650 | 2.2 | C | Immeasurable | |
| Example 2 | | | | | | | |
| Comparative | 300,000 | 0.9 | 2,100 | Uncoatable | — | — | — |
| Example 3 | | | | | | | |
| Comparative | 230,000 | 0.5 | 1,400 | 2.1 | C | Immeasurable | |
| Example 4 | | | | | | | |
| Comparative | 190,000 | 1.3 | 1,200 | 2.1 | B | 3.5 | 4.2 |
| Example 5 | | | | | | | |
| Comparative | CNF | | 780 | 2.1 | C | Immeasurable | |
| Example 6 | | | | | | | |

Referring to Table 1, the composite separator implemented based on an example embodiment of the disclosed technology includes carboxymethyl cellulose as a binder, with a weight-average molecular weight in the range of 180,000 to 280,000 g/mol and the degree of substitution in the range of 0.6 to 1.2. This composite separator provides excellent adhesive strength both between inorganic particles in the ceramic layer and between the substrate and ceramic layer interfaces. The separator also exhibited excellent heat resistance, and effectively suppressed a heat shrinkage phenomenon. An electrochemical device employing the composite separator implemented based on an example embodiment may achieve improved heat resistance and safety, while supporting higher capacity and output.

In contrast, the composite separators of Comparative Examples 1 to 5, which include carboxymethyl cellulose outside the above-discussed ranges of the weight-average molecular weight and/or the degree of substitution, could not be coated on the ceramic layer and exhibited greatly reduced adhesive strength and heat shrinkage rate. In addition, the composite separator of Comparative Example 6, which employed cellulose nanofiber instead of CMC, showed significantly reduced adhesive strength and heat shrinkage resistance.

Therefore, when the weight-average molecular weight of the carboxymethyl cellulose was within the range of 180,000 to 280,000 g/mol and the degree of substitution was within the range of 0.6 to 1.2 simultaneously, the composite separator exhibited both excellent adhesion between the ceramic layer and the substrate and effective suppression of heat shrinkage in both MD and TD directions. In contrast, outside these ranges, at least one of the adhesion or heat shrinkage properties was significantly deteriorated, indicating that the combination of the molecular weight (in the range of 180,000 to 280,000 g/mol) and degree of substitution (in the range of 0.6 to 1.2) provides an improvement in overall separator performance.

The composite separator of the disclosed technology may be widely applied to a green technology field such as electric vehicles, battery charging stations, and other solar power generations and wind power generations using batteries. In addition, the separator of the disclosed technology may be used in eco-friendly electric vehicles, hybrid vehicles, or others for preventing climate change by suppressing air pollution and greenhouse gas emissions.

The composite separator based on an example embodiment may exhibit excellent mechanical and thermal stability and ion conduction properties. Specifically, the composite separator based on an example embodiment includes a porous substrate and a ceramic layer including pores formed between inorganic particles that are connected and fixed by a binder. It exhibits excellent adhesive strength between the inorganic particles and between the inorganic particles and the substrate, and it may effectively suppress desorption of inorganic particles and shrinkage at a high temperature.

In addition, since the composite separator based on an example embodiment may maintain excellent adhesive strength and heat resistance even when the ceramic layer is formed with a very small thickness, an electrochemical device employing the separator may simultaneously meet the required safety, high capacity, and high output characteristics.

Only specific examples of implementations of certain embodiments are described. Variations, improvements and enhancements of the disclosed embodiments and other embodiments may be made based on the disclosure of this patent document.

What is claimed is:

1. A composite separator comprising:
a porous substrate; and
a ceramic layer disposed on at least one surface of the substrate, the ceramic layer including inorganic particles and a binder,
wherein the binder includes carboxymethyl cellulose having a weight-average molecular weight in a range of 180,000 to 280,000 g/mol and a degree of substitution in a range of 0.6 to 1.2.

2. The composite separator of claim 1, wherein the weight-average molecular weight of the carboxymethyl cellulose is in a range of 200,000 to 250,000 g/mol.

3. The composite separator of claim 1, wherein the degree of substitution of the carboxymethyl cellulose is in a range of 0.7 to 1.0.

4. The composite separator of claim 1, wherein the binder is included in an amount of 0.1 to 10 parts by weight relative to 100 parts by weight of the inorganic particles.

5. The composite separator of claim 1, wherein the binder includes at least 70 wt % of the carboxymethyl cellulose with respect to a total weight of the binder.

6. The composite separator of claim 1, wherein the binder consists of the carboxymethyl cellulose.

7. The composite separator of claim 1, wherein the inorganic particles include at least one of boehmite, BaSO₄, CeO₂, MgO, CaO, ZnO, Al₂O₃, TiO₂, BaTiO₃, HfO₂, SrTiO₃, SnO₂, NiO, ZrO₂, Y₂O₃, or SiC.

8. The composite separator of claim 1, wherein the inorganic particles have an average particle diameter in a range of 0.1 μm to 1.0 μm.

9. The composite separator of claim 1, wherein the porous substrate is hydrophilically surface-treated to be hydrophilic.

10. The composite separator of claim 1, wherein the ceramic layer has a total thickness in a range of 0.5 μm to 10 μm.

11. The composite separator of claim 1, wherein the composite separator exhibits heat shrinkage rates in machine direction (MD) and transverse direction (TD) of 4% or less, wherein the heat shrinkage rates in MD and TD are measured after the composite separator is allowed to stand at 150° C. for 60 minutes.

12. The composite separator of claim 1, wherein, when the composite separator is subjected to a cardboard test, a ratio of an area occupied by foreign matter smeared on a surface of a cardboard to a total area of the cardboard is 5% or less,
wherein the cardboard test comprises:
placing a black cardboard and a rubber pad having a size of 2 cm×10 cm sequentially on a ceramic layer of a composite separator specimen having a size of 5 cm×10 cm;
pulling the cardboard horizontally at a speed of 0.1 m/s while applying a pressure of 10 N to the rubber pad using a pressing device; and
evaluating a degree of foreign matter smeared on the surface of the cardboard.

13. A method for manufacturing a composite separator, the method comprising:
applying a composition for forming a ceramic layer including a binder and inorganic particles to at least one surface of a porous substrate; and
drying the composition to form a ceramic layer,
wherein the binder includes carboxymethyl cellulose having a weight-average molecular weight in a range of 180,000 to 280,000 g/mol and a degree of substitution in a range of 0.6 to 1.2.

14. The method of claim 13, wherein the weight-average molecular weight of the carboxymethyl cellulose is in a range of 200,000 to 250,000 g/mol.

15. The method of claim 13, wherein the degree of substitution of the carboxymethyl cellulose is in a range of 0.7 to 1.0.

16. The method of claim 13, wherein the inorganic particles have an average particle diameter in a range of 0.1 μm to 1.0 μm.

17. An electrochemical device comprising a positive electrode, a negative electrode, and a composite separator between the positive and negative electrodes,
wherein the composite separator includes:
a porous substrate; and
a ceramic layer disposed on at least one surface of the substrate, the ceramic layer including inorganic particles and a binder,
wherein the binder includes carboxymethyl cellulose having a weight-average molecular weight in a range of 180,000 to 280,000 g/mol and a degree of substitution in a range of 0.6 to 1.2.

18. The electrochemical device of claim 17, wherein the weight-average molecular weight of the carboxymethyl cellulose is in a range of 200,000 to 250,000 g/mol.

19. The electrochemical device of claim 17, wherein the degree of substitution of the carboxymethyl cellulose is in a range of 0.7 to 1.0.

20. The electrochemical device of claim 17, wherein the inorganic particles have an average particle diameter in a range of 0.1 μm to 1.0 μm.
